(19) United States
(12) Patent Application Publication
(10) Pub. No.: US 2009/0166917 A1
(43) Pub. Date: Jul. 2, 2009

(54) METHOD FOR PRODUCING EXTRUDED RESIN SHEET

(75) Inventors: Tomohiro Maekawa, Niihama-shi (JP); Kazuhiko Hatakeyama, Sanjo-shi (JP)

Correspondence Address: BIRCH STEWART KOLASCH & BIRCH, PO BOX 747, FALLS CHURCH, VA, 22040-0747, US

(73) Assignees: SUMITOMO CHEMICAL COMPANY, LIMITED, Tokyo (JP); ESCARBO SHEET CO., LTD, Mitsuke-shi (JP)

(21) Appl. No.: 12/338,757

(22) Filed: Dec. 18, 2008

(30) Foreign Application Priority Data
Dec. 21, 2007 (JP) 2007-331093

(51) Int. Cl. B29C 55/18; B29C 47/58; B29D 7/01

(52) U.S. Cl. 264/210.1

(57) ABSTRACT

An objective of the present invention is to provide a method for producing an extruded resin sheet in which the extruded resin sheet unlikely to be broken. The present invention provides a method for producing an extruded resin sheet comprising: heat-melting a thermoplastic resin and then extruding it into a sheet-form through a die; and pressure-forming the extruded molten thermoplastic resin sheet while nipping it with a first roll and a second roll; wherein at the both side edge portions of the outer circumferential surface of the second roll, the level difference portions which have a diameter smaller than a diameter of the roll central portion are provided, and the both side edge portions of the extruded molten thermoplastic resin sheet are nipped with the first roll and the level difference portions of the second roll.

### BACKGROUND OF THE INVENTION

1. Field of the Invention

The present invention relates to a method for producing an extruded resin sheet made of thermoplastic resin, and particularly to a method for producing an extruded resin sheet, in which the extruded resin sheet unlikely to be broken.

2. Description of the Related Art

Extruded resin sheets made of thermoplastic resin have been used in an extremely wide variety of applications, such as interior or exterior of automobiles, exterior of household electric appliances, optical applications including liquid crystal televisions and monitors. In production of an extruded resin sheet made of thermoplastic resin, the molten thermoplastic resin is generally nipped and pressed between two rolls to be made into a sheet form, and the shaped resin sheet is hauled and wound into a roll form while cooling.

However, the resin sheet becomes weak at the side edge portion of the sheet as the sheet to be shaped becomes thin in thickness, so the side edge portion tend to start rupturing, and the resin sheet often breaks during the line before wound up. This tendency is notable when breakable resins such as acrylic resins are employed, or when a sheet is shaped to have a thickness of 0.2 mm or less.

Japanese Patent Kokai Publication No. Hei 11(1999)-235747 discloses a roll configuration for pressure-forming thermoplastic resins which has a first roll composed of an elastic roll having a metal thin film at its outer circumferential surface and a second roll composed of a highly rigid metal roll. The roll configuration forms a sheet having a thickness of 0.1 to 0.6 mm.

However, the art of the document does not find the problem that the resin sheet becomes weak at the side edge portion as the sheet to be shaped becomes thin in thickness, so the side edge portion tends to start rupturing, and the resin sheet often breaks during the line before wound up.

### SUMMARY OF THE INVENTION

An objective of the present invention is to provide a method for producing an extruded resin sheet, in which the extruded resin sheet unlikely to be broken.

The present inventors investigated earnestly in order to solve the aforesaid subject. As a result, they found solving means composed of the following configurations, so that they have accomplished the present invention.

(1) A method for producing an extruded resin sheet comprising:

heat-melting a thermoplastic resin and then extruding it into a sheet-form through a die; and

pressure-forming the extruded molten thermoplastic resin sheet while nipping it with a first roll and a second roll; wherein

at the both side edge portions of the outer circumferential surface of the second roll, the level difference portions which have a diameter smaller than a diameter of the roll central portion are provided, and

the both side edge portions of the extruded molten thermoplastic resin sheet are nipped with the first roll and the level difference portions of the second roll.

(2) The method for producing an extruded resin sheet according to item (1), wherein thermoplastic resin is an acrylic resin.

(3) The method for producing an extruded resin sheet according to item (1), wherein difference between the outer circumferential surface-level of the roll central portion and the outer circumferential surface-level of the level difference portion at the position where the side edge portion of the sheet is present, is from 25 to 75 μm.

(4) The method for producing an extruded resin sheet according to item (1), wherein the first roll is an elastic roll having a metal thin film at its outer circumferential surface, and the second roll is a highly rigid metal roll.

(5) The method for producing an extruded resin sheet according to item (4), wherein the molten thermoplastic resin nipped between the rolls is shaped into a film while being pressed areally and uniformly because the elastic roll elastically deforms concavely along the outer circumferential surface of the metal roll with the molten thermoplastic resin intervening therebetween, so that the metal roll and the elastic roll are placed in areal contact with the molten thermoplastic resin under pressure.

(6) The method for producing an extruded resin sheet according to item (4), wherein a contact length of the metal roll and the elastic roll is from 1 to 20 mm.

(7) The method for producing an extruded resin sheet according to item (4), wherein a pressing linear pressure between the metal roll and the elastic roll is from 0.1 to 50 kgf/cm.

(8) The method for producing an extruded resin sheet according to item (4), wherein the elastic roll comprises an almost solidly-cylindrical core roll, a hollowly-cylindrical metal thin film disposed so that it covers the outer circumferential surface of the core roll, and a fluid enclosed between the core roll and the metal thin film.

(9) The method for producing an extruded resin sheet according to item (8), wherein the elastic roll is configured so that the temperature thereof can be controlled through control of the temperature of the fluid.

(10) The method for producing an extruded resin sheet according to item (4), wherein the elastic roll comprises an almost solidly-cylindrical core roll made of an elastic material and a hollowly-cylindrical metal thin film which covers the outer circumferential surface of the core roll.

(11) The method for producing an extruded resin sheet according to item (4), wherein the surface temperature (Tr) of the metal roll and the elastic roll is adjusted to within a range of (Th−20° C.)≦Tr≦(Th+20° C.) wherein Th is heat deformation temperature of thermoplastic resin constituting the extruded resin sheet.

(12) The method for producing an extruded resin sheet according to item (1), wherein the extruded resin sheet has a thickness of 0.2 mm or less.

### BRIEF DESCRIPTION OF DRAWINGS

FIG. 1 is a schematic illustration showing the method for producing an extruded resin sheet according to one embodiment of the present invention.

FIG. 2 is a schematic cross-sectional illustration showing a roll configuration according to one embodiment of the present invention.

FIG. 3 is a schematic illustration showing the molten thermoplastic resin and the second roll as seen from the direction of arrow A in FIG. 2.

FIG. 4 is a schematic cross-sectional illustration showing the both side edge portions of the sheet formed with the roll configuration according to one embodiment of the present invention.

FIG. 5 (a) or (b) is schematic illustration showing the second roll according to another embodiment of the present invention.

FIG. 6 is a schematic cross-sectional illustration showing a roll configuration according to another embodiment of the present invention.

### DETAILED DESCRIPTION OF THE INVENTION

The extruded resin sheet of the present invention is made of a thermoplastic resin. Thermoplastic resin may, without any particular limitations, be any resin which can be melt-processed, for example, general purpose plastics or engineering plastics such as polyvinyl chloride resin, acrylonitrile-butadiene-styrene resin, low density polyethylene resin, high density polyethylene resin, linear low density polyethylene resin, polystyrene resin, polypropylene resin, acrylonitrile-styrene resin, cellulose acetate resin, ethylene-vinyl acetate resin, acryl-acrylonitrile-styrene resin, acryl-chlorinated polyethylene resin, ethylene-vinyl alcohol resin, fluororesin, methyl methacrylate resin, methyl methacrylate-styrene resin, polyacetal resin, polyamide resin, polyethylene terephthalate resin, aromatic polycarbonate resin, polysulfone resin, polyether sulfone resin, methylpentene resin, polyarylate resin, polybutylene terephthalate resin, resin which contains an ethylenically unsaturated monomer unit with alicyclic structure, polyphenylene sulfide resin, polyphenylene oxide resin, polyetheretherketone resin; and rubbery polymers such as polyvinyl chloride-based elastomer, chlorinated polyethylene, ethylene-ethyl acrylate resin, thermoplastic polyurethane elastomer, thermoplastic polyester elastomer, ionomer resin, styrene-butadiene block polymer, ethylene-propylene rubber, polybutadiene resin, and acrylic rubber. These may be used singly or in the form of a blend of two or more species.

Among such resins, preferred is a resin selected from the group consisting of a methyl methacrylate-based resin containing 50% by weight or more of methyl methacrylate units, which resin is of good optical properties, a resin composition comprising 100 parts by weight of the foregoing methyl methacrylate-based resin and 100 parts by weight or less of a rubbery polymer added thereto, a styrene-based resin containing 50% by weight or more of styrene units, a resin composition comprising 100 parts by weight of the foregoing styrene-based resin and 100 parts by weight or less of a rubbery polymer added thereto, an aromatic polycarbonate resin and a resin which contains an ethylenically unsaturated monomer unit with alicyclic structure. Specifically preferred are acrylic resins such as a methyl methacrylate-based resin and a resin composition comprising 100 parts by weight of the methyl methacrylate-based resin and 100 parts by weight or less of a rubbery polymer added thereto.

The methyl methacrylate-based resin containing 50% by weight or more of methyl methacrylate units is a polymer which contains methyl methacrylate units as monomeric units. The content of the methyl methacrylate units is 50% by weight or more, more preferably is 70% by weight or more, and may be 100% by weight. A polymer having a methyl methacrylate unit content of 100% by weight is a methyl methacrylate homopolymer, which is obtained by polymerizing methyl methacrylate only.

Such a methyl methacrylate polymer may be a copolymer of methyl methacrylate and a monomer which can be copolymerized therewith. Examples of the monomer which can be copolymerized with methyl methacrylate include methacrylic esters other than methyl methacrylate. Examples of such methacrylic esters include ethyl methacrylate, butyl methacrylate, cyclohexyl methacrylate, phenyl methacrylate, benzyl methacrylate, 2-ethylhexyl methacrylate and 2-hydroxyethyl methacrylate. Further examples include acrylic esters such as methyl acrylate, ethyl acrylate, butyl acrylate, cyclohexyl acrylate, phenyl acrylate, benzyl acrylate, 2-ethylhexyl acrylate and 2-hydroxyethyl acrylate; unsaturated acids such as methacrylic acid and acrylic acid; halogenated styrenes such as chlorostyrene and bromostyrene; substituted styrenes, for example, alkyl styrenes such as vinyltoluene and α-methylstyrene; acrylonitrile, methacrylonitrile, maleic anhydride, phenylmaleimide and cyclohexylmaleimide. Such monomers may be used either solely or in combination.

The rubbery polymer in the present invention includes acrylic multilayer-structured polymers and graft copolymers obtained by graft polymerizing 95 to 20 parts by weight of an ethylenically unsaturated monomer, especially an acrylic unsaturated monomer, to 5 to 80 parts by weight of a rubbery polymer.

The acrylic multilayer-structured polymers include products having 20 to 60 parts by weight of a rubber elastic layer or elastomer layer enclosed and a hard layer as the outermost layer, and also may be products further having a hard layer as the innermost layer.

The rubber elastic layer or elastomer layer is a layer of an acrylic polymer having a glass transition point (Tg) of lower than 25° C. and is made of a polymer produced by crosslinking one or more monoethylenically unsaturated monomers, such as lower alkyl acrylate, lower alkyl methacrylate, lower alkoxy acrylate, cyanoethyl acrylate, acrylamide, hydroxy lower alkyl acrylate, hydroxy lower methacrylate, acrylic acid and methacrylic acid, with allyl methacrylate or the aforesaid multifunctional monomer.

A hard layer is a layer of an acrylic polymer having a Tg of 25° C. or higher and is made of a polymer composed of only an alkyl methacrylate having an alkyl group of 1 to 4 carbon atoms or a polymer comprising an alkyl methacrylate having an alkyl group of 1 to 4 carbon atoms mainly and a copolymerizable monofunctional monomer such as another alkyl methacrylate, alkyl acrylate, styrene, substituted styrene, acrylonitrile and methacrylonitrile, or may alternatively be of a crosslinked polymer resulting from polymerization with further addition of a multifunctional monomer.

For examples, polymers disclosed in Japanese Patent Kokoku Publication No. Sho 55 (1980)-27576, Japanese Patent Kokai Publication Nos. Hei 6 (1994)-80739 and Sho 49 (1974)-23292 correspond to such rubbery polymers.

Regarding the graft copolymers obtained by graft polymerizing 95 to 20 parts by weight of an ethylenically unsaturated monomer to 5 to 80 parts by weight of a rubbery polymer, diene rubbers, such as polybutadiene rubber, acrylonitrile-butadiene copolymer rubber and styrene-butadiene copolymer rubber; acrylic rubbers, such as polybutyl acrylate, polypropyl acrylate and poly-2-ethylhexyl acrylate; and ethylene-propylene-nonconjugated diene-based rubbers may be used as the rubbery polymer. Examples of the ethylenic monomers and their mixtures to be used for graft polymerizing to such rubbery polymers include styrene, acrylonitrile and alkyl (meth)acrylate. For example, products disclosed in Japanese Patent Kokai Publication No. Sho 55 (1980)-147514 and Japanese Patent Kokoku Publication No. Sho 47 (1982)-9740 can be used as such graft copolymers.

The dispersion amount of a rubbery polymer is from 0 to 100 parts by weight, and preferably is from 3 to 50 parts by weight to 100 parts by weight of a methyl methacrylate-based or styrene-based resin. A case where the amount is greater than 100 parts by weight is undesirable because the rigidity of a sheet will deteriorate.

The styrene-based resin containing 50% by weight or more of styrene units is a polymer which comprises styrene-based monofunctional monomer units as a major component, for example at 50% by weight or more, and may be either a homopolymer of a styrene-based monofunctional monomer or a copolymer of a styrene-based monofunctional monomer and a monofunctional monomer copolymerizable therewith.

The styrene-based monofunctional monomer is a compound that has a styrene skeleton and has, in the molecular, one radically polymerizable double bond, for example, styrene and substituted styrenes such as halogenated styrenes including chlorostyrene and bromostyrene, and alkylstyrenes including vinyltoluene and α-methylstyrene.

The monofunctional monomer copolymerizable with a styrene-based monofunctional monomer is a compound that has, in the molecule, one radically polymerizable double bond and is copolymerizable at this double bond to a styrene-based monofunctional monomer. Examples of this type of monomer include methacrylic esters such as methyl methacrylate, butyl methacrylate, cyclohexyl methacrylate, phenyl methacrylate, benzyl methacrylate, 2-ethylhexyl methacrylate and 2-hydroxyethyl methacrylate; acrylic ester, such as methyl acrylate, ethyl acrylate, butyl acrylate, cyclohexyl acrylate, phenyl acrylate, benzyl acrylate, 2-ethylhexyl acrylate and 2-hydroxyethyl acrylate; and acrylonitrile. Methacrylic esters such as methyl methacrylate are used preferably. These are used solely or in combination.

The aromatic polycarbonate resin generally includes those obtained by polymerizing a carbonate prepolymer by a solid phase transesterification method or those obtained by polymerizing a cyclic carbonate compound by a ring-opening polymerization method as well as those obtained by causing a dihydric phenol and a carbonate precursor to react together by an interfacial polycondensation method or a melt transesterification method.

Representative examples of the dihydric phenol used here include hydroquinone, resorcinol, 4,4′-dihydroxydiphenyl, bis(4-hydroxyphenyl)methane, bis{(4-hydroxy-3,5-dimethyl)phenyl}methane, 1,1-bis (4-hydroxyphenyl)ethane, 1,1-bis(4-hydroxyphenyl)-1-phenylethane, 2,2-bis(4-hydroxyphenyl)propane (a common name is bisphenol A), 2,2-bis{(4-hydroxy-3-methyl)phenyl}propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α″-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxydiphenylsulfone, 4,4′-dihydroxydiphenylsulfoxide, 4,4′-dihydroxydiphenylsulfide, 4,4′-dihydroxydiphenyl ketone, 4,4′-dihydroxydiphenyl ether, and 4,4′-dihydroxydiphenyl ester. These may be used either solely or in the form of a mixture of two or more of them.

Particularly preferred is a homopolymer or copolymer obtained from at least one bisphenol selected from the group consisting of bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane and α,α′-bis(4-hydroxyphenyl)-m-diisopropylbenzene.

Especially, a homopolymer of bisphenol A and a copolymer of 1,1-bis(4-hydroxyphenyl)-3,3,5-trimethylcyclohexane with at least one dihydric phenol selected from the group consisting of bisphenol A, 2,2-bis{(4-hydroxy-3-methyl)phenyl}propane and α,α′-bis(4-hydroxyphenyl)-m-diisopropylbenzene are used preferably.

For example, a carbonyl halide, a carbonate ester or a haloformate is used as a carbonate precursor. Specific examples include phosgene, diphenyl carbonate, or a dihaloformate of a dihydric phenol.

Examples of the resin which contains an ethylenically unsaturated monomer unit with alicyclic structure include norbornene-based polymers and vinyl alicyclic hydrocarbon-based polymers. That type of resin is characterized by containing an alicyclic structure in the repeating units of the polymer. The resin may have an alicyclic structure in the main chain and/or in a side chain. From the viewpoint of light transmissibility, resins having an alicyclic structure in the main chain are preferred.

Specific examples of such polymer resins containing an alicyclic structure include norbornene-based polymers, monocyclic olefin-based polymers, cyclic conjugated diene-based polymers, vinyl alicyclic hydrocarbon-based polymers, and their hydrogenated derivatives. Among these, hydrogenated norbornene-based polymers and vinyl alicyclic hydrocarbon-based polymers or their hydrogenated derivatives are preferred from the viewpoint of light transmissibility. Hydrogenated norbornene-based polymers are more preferable.

Depending on intended purpose, a light diffusing agent, a matting agent, a UV absorber, a surfactant, an impact resisting agent, a polymer type antistatic agent, an antioxidant, a flame retarder, a lubricant, a dye, a pigment, etc. may be added to thermoplastic resin to be used in the present invention without any problems.

The extruded resin sheet in the present invention is 2 mm or less, preferably is 1 mm or less, and more preferably is 0.5 mm or less, and further more preferably is 0.2 mm or less in thickness. The thinner the thickness, the more useful the present invention, and the easier the handling ability as a sheet. If the thickness is however too thin, sheet strength falls to become breakable. So the thickness is usually 0.03 mm or more, preferably 0.04 mm or more. The thickness of an extruded resin sheet can be adjusted by adjusting the thickness of a molten thermoplastic resin 4 to be extruded through a die 3 described below, the clearance between two chill rolls 5, and so on.

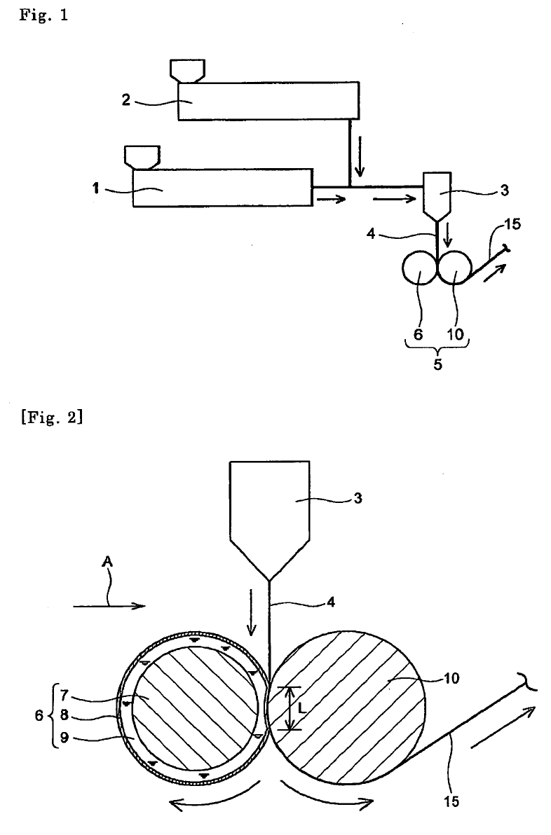

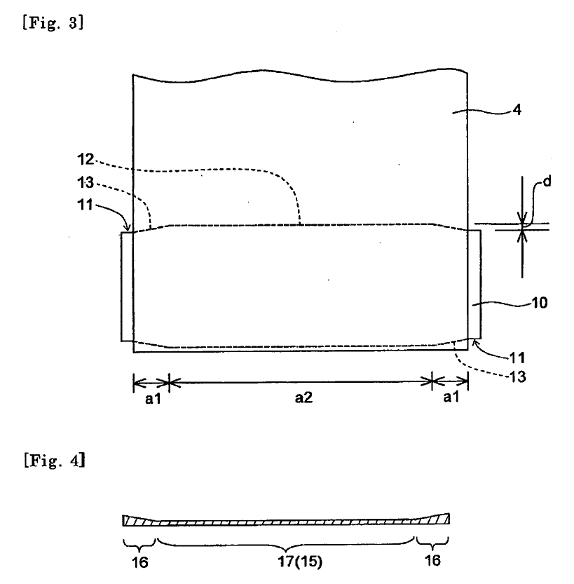

The extruded resin sheet of the present invention made of the aforementioned thermoplastic resin can be produced as follows. Hereafter, one embodiment of the method for producing an extruded resin sheet according to the present invention is described in detail with reference to drawings. FIG. 1 is a schematic illustration showing the method for producing an extruded resin sheet according to this embodiment. FIG. 2 is a schematic cross-sectional illustration showing the roll configuration according to this embodiment. FIG. 3 is a schematic illustration showing the molten thermoplastic resin and the second roll as seen from the direction of arrow A in FIG. 2. FIG. 4 is a schematic cross-sectional illustration showing the both side edge portions of the sheet formed with the roll configuration of this embodiment.

The extruded resin sheet of this embodiment can be produced by an ordinary extrusion forming method. That is, as shown in FIG. 1, a thermoplastic resin, which is to become a substrate, is extruded through a die 3 into a sheet form while it is heated and melt-kneaded in an extruder 1 and/or an extruder 2.

When making an extruded resin sheet have a multilayer structure, it is possible to produce the film by a co-extrusion forming method. For example, the purpose can be attained by co-extruding a thermoplastic resin to become a substrate from the extruder 1 and another thermoplastic resin which is intended to laminate from the extruder 2. Co-extrusion can be performed by extruding and laminating thermoplastic resins through the die 3 while heating and thereby melt-kneading thermoplastic resins in the different extruders 1 and 2, respectively.

Examples of the extruders 1, 2 include single screw extruders and twin screw extruders. The number of the extruders is not necessarily limited to 2 and three or more extruders may be used. A T die is ordinarily used as the die 3. Besides single layer dies through which a thermoplastic resin is extruded in a single layer, multilayer dies through which two or more thermoplastic resins transferred under pressure independently from the extruders 1, 2 are laminated and co-extruded, such as feed block dies and multimanifold dies, may be employed.

When the molten thermoplastic resin 4 extruded through the die 3 as described above is formed while being nipped with two chill rolls 5 which are oppositely arranged almost horizontally, an extruded resin sheet 15 is obtained. The chill rolls 5 are configurated with a first roll and a second roll, and in this embodiment, as shown in FIG. 2, an elastic roll having a metal thin film 8 at its circumferential part, namely, a metal elastic roll 6 is used as the first roll, and a highly rigid metal roll 10 is used as the second roll. At least one between the metal elastic roll 6 and the metal roll 10 is connected to a rotary driving device, such as a motor, and the rolls are configured so that they can rotate at specified circumferential speeds.

The metal elastic roll 6, which is the first roll, has a core roll 7, which is almost solidly-cylindrical and freely rotatable, and a hollowly-cylindrical metal thin film 8 which is arranged so that it can cover the circumferential surface of the core roll 7 and which will be in contact with the molten thermoplastic resin 4. A fluid 9 is enclosed in between the core roll 7 and the metal thin film 8, whereby the metal elastic roll 6 can exhibit elasticity. The core roll 7 is not particularly restricted and may be made of stainless steel, for example.

The metal thin film 8 is made of stainless steel, for example. The thickness thereof preferably is about 2 mm to about 5 mm. The metal thin film 8 preferably has flexurality, flexibility, and the like. The metal thin film preferably is of a seamless structure having no welded seam. The metal elastic roll 6 having such a metal thin film 8 has great ease of use because it excels in durability and it can be handled like ordinary mirror-finished rolls if the metal thin layer 8 is mirror finished and, if patterns or irregularities are provided to the metal thin film 8, it can serve as a roll capable of transferring the profile thereof.

The metal thin film 8 is fixed at both the ends of the core roll 7 and a fluid 9 is enclosed to between the core roll 7 and the metal thin film 8. Examples of the fluid 9 include water and oil. By controlling the temperature of the fluid 9, it is possible to make the metal elastic roll 6 temperature-controllable. Thereby it becomes easy to control into predetermined relation, surface temperature (Tr) of the metal elastic roll 6 and the metal roll 10 described later, and heat deformation temperature (Th) of thermoplastic resin which constitutes the extruded resin sheet, and it is possible to increase the production capacity. For the temperature control, conventional controlling techniques such as PID control and ON-OFF control may be employed. Gas such as air can also be used instead of the fluid 9.

By using the metal elastic roll 6, it is possible to inhibit strain from remaining in the sheet 15 with the use of elastic deformation of the metal elastic roll 6. That is, when a molten thermoplastic resin 4 is nipped between the metal elastic roll 6 and the metal roll 10, the metal elastic roll 6 deforms elastically along the outer circumferential surface of the metal roll 10 with the molten thermoplastic resin 4 intervening therebetween, and the metal elastic roll 6 and the metal roll 10 come into contact with each other over a contact length L with separation by the molten thermoplastic resin 4. The metal elastic roll 6 and the metal roll 10 are thereby placed in areal contact with the molten thermoplastic resin 4 under pressure. As a result, the molten thermoplastic resin 4 nipped between the rolls is formed into a sheet while being pressed areally and uniformly. By producing a sheet in this fashion, it is possible to inhibit strain from remaining in a film. The contact length L used herein is the length in extrusion direction of the area where the metal elastic roll 6 and the metal roll 10 contact with the molten thermoplastic resin intervening therebetween.

The contact length L may be any value such that it is possible to inhibit strain from remaining in a film. Therefore, the metal elastic roll 6 is required to have elasticity as high as that the metal elastic roll 6 elastically deforms to produce the appropriate contact length L. The contact length L is 1 to 20 mm, preferably is 2 to 10 mm, and more preferably is 3 to 7 mm. The contact length L can be adjusted to a desired value by optionally adjusting the thickness of the metal thin film 8, the amount of the fluid 9 enclosed, etc.

The pressing linear pressure, which is the pressure between the metal elastic roll 6 and the metal roll 10 in contact with each other, is appropriately adjusted within a range where a proper contact length is provided. Generally, the pressing linear pressure is from 0.1 kgf/cm to 50 kgf/cm, preferably is from 0.5 kgf/cm to 30 kgf/cm, and more preferably is from 1 kgf/cm to 25 kgf/cm. When the pressing linear pressure is too low, it tends to become difficult to apply pressure areally and uniformly and tends to cause unevenness. When the pressure is too high, the resulted film tends to break, and the elastic roll tends to become short in life. The pressing linear pressure used herein is the pressure applied to a roll which is expressed as the value of pressure per 1 cm in roll width. In the case when a roll having a width of 100 cm is pressed at 300 kgf, the pressing linear pressure is 3 kgf/cm.

The highly rigid metal roll 10, which is the second roll, is a wrapper roll around which a thermoplastic resin after being nipped between the metal elastic roll 6 and the metal roll 10 is wrapped. Specific examples include drilled rolls and spiral rolls. The surface state of the metal roll 10 may either be mirror-finished or have patterns, irregularities, etc.

The metal roll 10 in this embodiment, as shown in FIG. 3, has the level difference portions 13, 13 which have a diameter smaller than a diameter of the roll central portion 12, at the both side edge portions 11, 11 of the outer circumferential surface. The level difference portion 13 in this embodiment is comprised of a sloped surface which slopes from the roll central portion 12 for the edge portion 11.

Thermoplastic resin 4 is formed with being nipped between the level difference portion 13 and the metal elastic roll 6 opposite to the level difference portion 13 as thermoplastic resin is nipped with the metal elastic roll 6 and the metal roll 10. Thereby, it is possible to form the both side edge portions 16, 16 of the sheet thicker in thickness than the central portion 17 of the sheet, so that the both side edge portions 16, 16 of the sheet are improved in strength. The sheet is therefore prevented from breaking from the side edge portions even tensile force is applied to the formed sheet. The both side edge portions 16, 16 of the sheet are cut out with a slitter for cutting out the both side edge portions 16, 16 in the hauling step described later, and the sheet central portion 17 after the both side edges 16, 16 are cut out, becomes an extruded resin sheet 15.

The level difference d is preferably 25 to 75 μm. The level difference d lower than 25 μm may not provide sufficient strength to the side edge portion 16 of the sheet. The level difference d higher than 75 μm may provide excessive strength to the side edge portion 16 of the sheet, and makes it easy to crack by contrast, so it is not preferred. The total value of level difference d and thickness of the sheet central portion (that is, thickness of the extruded resin sheet 15) makes thickness of the side edge portion of the sheet. That is, the level difference as used herein means difference between the outer circumferential surface-level of the roll central portion and the outer circumferential surface-level of the level difference portion at the position where the side edge portion of the sheet is present.

The level difference portion 13 preferably has a length a1 of 0.2 to 5% when surface length of the metal roll 10 is regarded as 100%. If the length a1 of the level difference portion 13 is smaller than 0.2%, strength provided to the side edge portion 16 of the sheet may become insufficient. If the length a1 is larger than 5%, length of the sheet central portion 17, that is width of the extruded resin sheet 15 becomes narrow, and not preferred. The length a1 of the level difference portion 13 means length of the level difference portion 13 shown as planar view. The surface length of the metal roll 10 means total value of length a1, a1 of the both level difference portions 13, 13 and length a2 of the roll central portion 12. An arbitrary value may be employed for the surface length of the metal roll 10 depending on width of the extruded resin sheet to be formed, and not specifically limited.

In shaping the molten thermoplastic resin 4 by nipping with metal elastic roll 6 and the metal roll 10, it is necessary to nip with the rolls before or during an operation of cooling the molten thermoplastic resin 4 to solidify. Specifically, it is preferable to adjust the surface temperature (Tr) of the metal elastic roll 6 and the metal roll 10 to the range of (Th−20° C.)≦Tr≦(Th+20° C.), preferably (Th−15° C.)≦Tr≦(Th+10° C.), and more preferably (Th−10° C.)≦Tr≦(Th+5° C.), base on the heat deformation temperature (Th) of thermoplastic resin. While heat deformation temperature (Th) of thermoplastic resin is not particularly limited, it is usually about 60 to 200° C. Heat deformation temperature (Th) of a thermoplastic resin is a temperature measured in accordance with ASTM D-648.

On the other hand, if the surface temperature (Tr) becomes a temperature lower than (Th−20° C.), shrinkage ratio with heat of the sheet tends to become large. If the surface temperature (Tr) becomes a temperature higher than (Th+20° C.), detachment marks from the rolls tend to become remarkable.

The present invention is directed also to multilayer sheets in which different materials are laminated. The heat deformation temperature (Th) in such a case is on the basis of a resin highest in heat deformation temperature (Th).

A sheet-formed thermoplastic resin after being nipped between the metal elastic roll 6 and the metal roll 10 is wrapped around the metal roll 10 and then is hauled with a haul-off roll (not shown) while being cooled on a carrying roll. The both side edge portions 16, 16 of the sheet are cut out with a slitter for cutting out the both side edge portions 16, 16 of the sheet, not shown, in the hauling step to obtain an extruded resin sheet 15.

The extruded resin sheet 15 is, for example, applicable to interior or exterior of automobiles, exterior of home electric appliances, optical applications such as a light guiding panel or a diffusing panel of mobile phones, but applications of the present invention are not limited thereto.

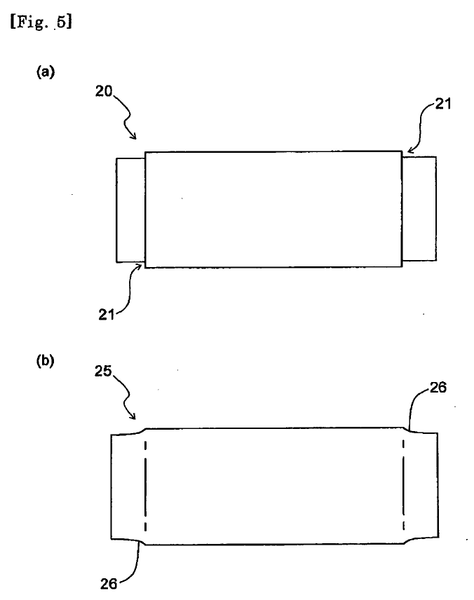

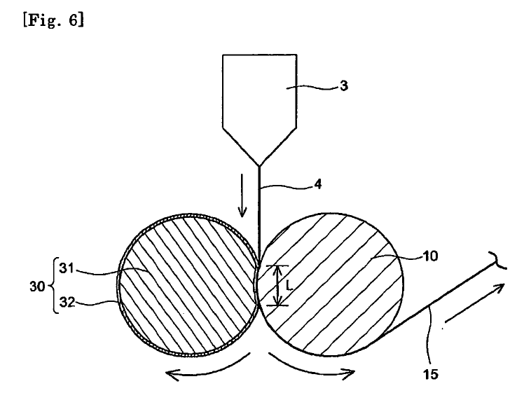

While several preferable embodiments of the present invention have been described above, the present invention is not limited to the foregoing embodiments and various improvements or modifications may be made within the scope of the claims. For example, while the level difference portion 13 is composed of a sloped surface which slopes from the central portion 12 of the roll for the edge portion 11 in the foregoing embodiment, shape of the level difference portion of the present invention is not limited thereto. For example, the shape as shown in FIGS. 5 (a) and (b) may be adopted.

That is, as shown in FIG. 5 (a), the level difference portion 21 provided on the outer circumferential surface at the both side edge portions of the second roll 20, or as shown in FIG. 5 (b), the level difference portion 26 of curved surface form provided on the outer circumferential surface at the both side edge portions of the second roll 25. The other configurations are the same as the level difference portion 13 which is the previously described embodiment.

Although the level difference portion 13 is provided only on the second roll in the previously described embodiment, the level difference portion may also be provided on the first roll. In this case, the total value made of level difference d of the second roll and level difference d of the first roll is preferably 25 to 75 μm.

The metal elastic roll 30 as shown in FIG. 6 may be employed instead of the metal elastic roll 6. The metal elastic roll 30 according to this embodiment is a roll in which the circumferential surface of the core roll 31, which is almost solidly-cylindrical and freely rotatable, is covered with a hollowly-cylindrical metal thin film 32.

The core roll 31 is made of an elastic material. The material which constitutes the core roll is not particularly restricted if it is an elastic material which has heretofore been used as a roll for forming films. Examples thereof include rubber rolls made of rubber such as silicone rubber. The metal elastic roll 30 can thereby exhibit elasticity. The aforesaid contact length L and pressing linear pressure can be adjusted to appropriate values also by adjusting the hardness of the rubber.

The metal thin film 32 is made of stainless steel, for example. The thickness thereof preferably is about 0.2 mm to about 1 mm.

The metal elastic roll 30 can be configured to be temperature-controllable by, for example, mounting a back-up chill roll to the metal elastic roll 30. The other configurations are the same as the metal elastic roll 6 which is the previously described embodiment.

In another possible embodiment, a plurality of rolls are disposed after the metal roll 10, and thermoplastic resin wrapped around the metal roll 10 is successively nipped between one roll and another roll next thereto to be wrapped.

The method of the present invention is able to form the both side edge portions of the sheet thicker in thickness than the central portion of the sheet as thermoplastic resin is pressure-formed with nipped between two rolls, so that the both side edge portions of the sheet are improved in strength. The sheet is therefore prevented from breaking from the side edge portion of the sheet even when tensile force is applied to the formed sheet.

In particular, when the method of the present invention is applied in order to obtain a breakable acrylic resin sheet or a thin sheet, the usefulness of the present invention will increase more.

### EXAMPLES

The present invention will be described in more detail below with reference to Examples, but the invention is not limited to the Examples. Configuration of the extrusion apparatus used in the following Examples and Comparative Examples is as follows:

Extruder 1: Screw diameter of 100 mm, single screw, with a vent (manufactured by Hitachi Zosen Corp.);
Die 3: T die, lip width of 1500 mm, lip gap of 1 mm (manufactured by Hitachi Zosen Corp.);
Roll: Horizontal type, two chill rolls of 1600 mm in length, 300 mm in diameter.

Extruders 1 and die 3 were arranged as shown in FIG. 1. Then, the roll which was closest to Extruders 1 was named the first roll and the wrapper roll was named the second roll. The rolls were configured as follows.

### <Roll Configuration 1>

The configuration shown in FIGS. 2 and 3 was named Roll configuration 1. Specifically, the first roll and the second roll were configured as follows.

### (The First Roll)

The metal elastic roll 6, in which the metal thin film 8 was arranged so that it could cover the outer circumferential surface of the core roll 7 and the fluid 9 was filled to between the core roll 7 and the metal thin film 8, was used as the first roll. The core roll 7, the metal thin film 8, and the fluid 9 are as follows.

Core roll 7: Made of stainless steel;
Metal thin film 8: Mirror-finished metal sleeve made of stainless steel having a thickness of 2 mm;
Fluid 9: Oil. The metal elastic roll 6 was made temperature-controllable through temperature control of the oil. More specifically, the oil was made temperature-controllable through heating and cooling of the oil by ON-OFF control of a temperature controller, and the oil was circulated through between the core roll 7 and the metal thin film 8.

### (The Second Roll)

A mirror-finished stainless steel spiral roll, at the both side edge portions on the outer circumferential surface of which level difference portions 13, 13 (sloped surface) was formed, was made into a highly rigid metal roll 10, which was used as the second roll.

As to the level difference portion 13, the level difference d was made to 50 μm, and the length a1 was made to 0.3% (that is, 5 mm) when surface length of the metal roll 10 was regarded as 100%. The contact length L, over which the metal elastic roll 6 and the metal roll 10 were in contact with each other with separation by a molten thermoplastic resin 4, was adjusted to 5 mm and the pressing linear pressure was adjusted to 20 kgf/cm.

### <Roll Configuration 2>

Highly rigid metal rolls (mirror-finished stainless steel spiral rolls), at the both side edge portions on the outer circumferential surface of which no level difference portion was formed, were used as both the first roll and the second roll. In this case, the pressing linear pressure was adjusted to 100 kgf/cm.

Thermoplastic resins used in the following Examples and Comparative Examples are as follows.

Resin 1: Acrylic composition in which 70% by weight of a copolymer of methyl methacrylate/methyl acrylate=96/4 (weight ratio) was incorporated with 30% by weight of an acrylic multilayer elastic material obtained in the following Reference Example. The heat deformation temperature (Th) was 100° C.
Resin 2: Copolymer in which methyl methacrylate/methyl acrylate=94/6 (weight ratio). The heat deformation temperature (Th) was 100° C.

### Reference Example

### Production of Rubbery Polymer

In accordance with the method disclosed in the Example section of Japanese Patent Kokoku Publication No. Sho 55(1980)-27576, an acrylic multilayer elastic material of three-layer structure was produced. Specifically, 1700 g of ion exchanged water, 0.7 g of sodium carbonate and 0.3 g of sodium persulfate were charged into a glass reactor having a capacity of 5 L first, followed by stirring under nitrogen flow. Subsequently, 4.46 g of PELEX OT-P (produced by Kao Co., Ltd.), 150 g of ion exchanged water, 150 g of methyl methacrylate and 0.3 g of allyl methacrylate were charged and then heated to 75° C., followed by stirring for 150 minutes.

Then, a mixture of 689 g of butyl acrylate, 162 g of styrene and 17 of allyl methacrylate and a mixture of 0.85 g of sodium persulfate, 7.4 g of PELEX OT-P and 50 g of ion exchanged water were added through different inlet ports over 90 minutes, followed by polymerization for 90 minutes.

After the completion of the polymerization, a mixture of 326 g of methyl acrylate and 14 g of ethyl acrylate, and 30 g of ion exchanged water containing 0.34 g of sodium persulfate dissolved therein were further added through different inlet ports over 30 minutes.

When the addition was finished, the mixture was further held for 60 minutes to complete the polymerization. A resulting latex was poured into a 0.5% aqueous aluminum chloride solution, so that a polymer was condensed. The polymer was washed with hot water 5 times and then dried to yield an acrylic multilayer elastic material.

### Examples 1 to 3 and Comparative Examples 1 to 3

### Preparation of Extruded Resin Sheet

The resin of the kind shown in Table 1 was melt-kneaded in Extruder 1, and then was fed to the die 3, successively. Then, the molten thermoplastic resin 4 extruded through the die 3 was shaped while being nipped between the first roll and the second roll of the roll configuration shown in Table 1 and wrapped around the second roll, and hauled with a hauling roll while being cooled on a conveying roll to obtain an extruded resin sheet having a thickness shown in Table 1. In examples 1 to 3, the molten thermoplastic resin 4 was formed with being nipped between the level difference portion 13 and the first roll as thermoplastic resin was nipped between the first roll and the second roll. It is noted that ‘Surface temp. of first roll’ and ‘Surface temp. of second roll’ given in Tables 1 and 2 are values actually measured.

### <Evaluation>

For each of the obtained extruded resin sheets (Examples 1 to 3 and Comparative Examples 1 to 3), the state of forming was checked visually. The used criteria for evaluation were as follows:

◯: The sheet was formed without problems.
x: The sheet was broken from the side edge portion.

TABLE 1

| | Extruder 1 | | | | Surface temp. | Surface temp. | |
|---|---|---|---|---|---|---|---|
| | | Th | Thickness | Roll | of first roll | of second roll | Evaluation |
| | Resin kind | ° C. | μm | configuration | ° C. | ° C. | results |
| Ex. 1 | 1 | 100 | 50 | 1 | 95 | 103 | ∘ |
| Comp. Ex. 1 | 1 | 100 | 50 | 2 | 95 | 103 | x |
| Ex. 2 | 2 | 100 | 80 | 1 | 96 | 102 | ∘ |
| Comp. Ex. 2 | 2 | 100 | 80 | 2 | 96 | 102 | x |
| Ex. 3 | 2 | 100 | 150 | 1 | 95 | 97 | ∘ |
| Comp. Ex. 3 | 2 | 100 | 150 | 2 | 95 | 97 | x |

As shown in Table 1, Examples 1 to 3 form extruded resin sheets having thicknesses of 50 μm, 80 μm and 150 μm without problems, whereas Comparative Examples 1 to 3 break them from the side edge portion of the sheet.

What is claimed is:

1. A method for producing an extruded resin sheet comprising:
heat-melting a thermoplastic resin and then extruding it into a sheet-form through a die; and
pressure-forming the extruded molten thermoplastic resin sheet while nipping it with a first roll and a second roll; wherein
at the both side edge portions of the outer circumferential surface of the second roll, the level difference portions which have a diameter smaller than a diameter of the roll central portion are provided, and
the both side edge portions of the extruded molten thermoplastic resin sheet are nipped with the first roll and the level difference portions of the second roll.

2. The method for producing an extruded resin sheet according to claim 1, wherein thermoplastic resin is an acrylic resin.

3. The method for producing an extruded resin sheet according to claim 1, wherein difference between the outer circumferential surface-level of the roll central portion and the outer circumferential surface-level of the level difference portion at the position where the side edge portion of the sheet is present, is from 25 to 75 μm.

4. The method for producing an extruded resin sheet according to claim 1, wherein the first roll is an elastic roll having a metal thin film at its outer circumferential surface, and the second roll is a highly rigid metal roll.

5. The method for producing an extruded resin sheet according to claim 4, wherein the molten thermoplastic resin nipped between the rolls is formed into a film while being pressed areally and uniformly because the elastic roll elastically deforms concavely along the outer circumferential surface of the metal roll with the molten thermoplastic resin intervening therebetween, so that the metal roll and the elastic roll are placed in areal contact with the molten thermoplastic resin under pressure.

6. The method for producing an extruded resin sheet according to claim 4, wherein a contact length of the metal roll and the elastic roll is from 1 to 20 mm.

7. The method for producing an extruded resin sheet according to claim 4, wherein a pressing linear pressure between the metal roll and the elastic roll is from 0.1 to 50 kgf/cm.

8. The method for producing an extruded resin sheet according to claims 4, wherein the elastic roll comprises an almost solidly-cylindrical core roll, a hollowly-cylindrical metal thin film disposed so that it covers the outer circumferential surface of the core roll, and a fluid enclosed between the core roll and the metal thin film.

9. The method for producing an extruded resin sheet according to claim 8, wherein the elastic roll is configured so that the temperature thereof can be controlled through control of the temperature of the fluid.

10. The method for producing an extruded resin sheet according to claims 4, wherein the elastic roll comprises an almost solidly-cylindrical core roll made of an elastic material and a hollowly-cylindrical metal thin film which covers the outer circumferential surface of the core roll.

11. The method for producing an extruded resin sheet according to claim 4, wherein the surface temperature (Tr) of the metal roll and the elastic roll is adjusted to within a range of (Th−20° C.)≦Tr≦(Th+20° C.) wherein Th is heat deformation temperature of thermoplastic resin constituting the extruded resin sheet.

12. The method for producing an extruded resin sheet according to claim 1, wherein the extruded resin sheet has a thickness of 0.2 mm or less.
